(19) United States
(12) Patent Application Publication
(10) Pub. No.: US 2016/0370649 A1
(43) Pub. Date: Dec. 22, 2016

(54) METHOD OF MANUFACTURING A COLOR FILTER

(71) Applicant: SHENZHEN CHINA STAR OPTOELECTRONICS TECHNOLOGY CO., LTD., Shenzhen, Guangdong (CN)

(72) Inventors: Ruijun ZHANG, Shenzhen, Guangdong (CN); Shijian QIN, Shenzhen, Guangdong (CN)

(73) Assignee: Shenzhen China Star Optoelectronics Technology Co., Ltd., Shenzhen, Guangdong (CN)

(21) Appl. No.: 14/436,027

(22) PCT Filed: Jan. 7, 2015
(86) PCT No.: PCT/CN2015/070262

§ 371 Date: Apr. 15, 2015

(30) Foreign Application Priority Data
Dec. 26, 2014 (CN) 201410833241.4

(51) Int. Cl. G02F 1/1335; G02B 5/20

(52) U.S. Cl. CPC G02F 1/133516; G02B 5/201; G02F 1/133512; G02F 2001/133519

(57) ABSTRACT

The disclosure is related to a method for manufacturing a color filter comprises coating a light shielding layer on a substrate, forming a trench on the light shielding layer to form a black matrix layer and a sub-pixel region. The black matrix layer comprises a top surface and a bottom surface. The bottom surface is bounded on the substrate. The top surface is at the surface of the black matrix layer away from the substrate. The area of the bottom surface is less than the area of top surface. The black matrix layer and the sub-pixel region are formed in an alternate interval manner. Each sub-pixel region is positioned between two adjacent black matrixes. A color filter layer is formed at the sub-pixel region. The color filter obtained by the method of the disclosure has a smooth surface without the step and avoids the leakage of light.

### CROSS REFERENCE TO RELATED APPLICATION

This application claims priority on “Method of Manufacturing a Color Filter” of Patent Application No(s). 2014/10833241.4 filed on Dec. 26, 2014, the entire content of which is hereby incorporated by reference.

### BACKGROUND OF THE INVENTION

1. Field of the Invention

The disclosure is related the field of liquid crystal display technology, and more particularly to a method for manufacturing color filter.

2. Description of Related Art

The color filter substrate is used for the display apparatus to display color images. The color filter substrate comprises color filter elements, e.g. red filter element, green filter element and blue filter element, disposed at the different locations of the substrate. The process of the color filter element generally comprises the lithography process. The temperature for the lithography process is usually higher than 200 degree Celsius. The color filter substrates of the flexible display apparatus usually use the flexible materials for the substrate, for example polyethylene terephthalate (PET). However, the glass transition temperature (Tg) of the plastic substrate is usually much lower than the temperature for the lithography process. For example, the glass transition temperature of polyethylene terephthalate is about 80 degree Celsius. Therefore, the plastic substrate is not suitable for the lithography process.

In order to avoid the leakage of light, the color filter needs to overlap the black matrix partially in current production process of the color filter because of the color filter layer shrinks in baking process. If the color filter does not overlap the black matrix, the defect of the leakage of light will occur after the baking in the lithography process. Although the method of the color filter overlapping the black matrix partially avoids the leakage of light, the overlap area of the color filter and black matrix is higher than the sub pixel region and thus forms the step. The step will affect the follow-up process of cell gap alignment and disturb the liquid crystal alignment.

### SUMMARY OF THE INVENTION

The embodiment of the disclosure provides a method for manufacturing the color filter so that the color filter is provided with smooth surface without the step and the leakage of light is avoided.

In order to achieve the above purpose, the disclosure provides the following technical solutions.

According to an embodiment of the disclosure, the disclosure provides a method for manufacturing a color filter comprising coating a light shielding layer on a substrate, then forming a trench on the light shielding layer to form a black matrix layer and a sub-pixel region; the black matrix layer comprising a top surface and a bottom surface; the bottom surface bounded on the substrate; the top surface being at the surface of the black matrix layer away from the substrate; the area of the bottom surface being less than the area of the top surface; the black matrix layer and the sub-pixel region formed in an alternate interval manner; wherein each sub-pixel region is positioned between two adjacent black matrixes; and forming a color filter layer at the sub-pixel region.

In one embodiment of the method for manufacturing a color filter, the step of coating the light shielding layer on the substrate comprises forming a film on the substrate in a brushing and/or a spraying manner, and then carrying out a curing treatment for the film by UV light.

In one embodiment of the method for manufacturing a color filter, the film thickness is uniform.

In one embodiment of the method for manufacturing a color filter, the light shielding layer is cut by water-cutting technique to form the trench on the light shielding layer.

In one embodiment of the method for manufacturing a color filter, the process of cutting the light shielding layer uses an oblique cutting method.

In one embodiment of the method for manufacturing a color filter, the step of forming a color filter layer at the sub-pixel region comprises coating a pixel resin and then carrying out a curing treatment by UV light.

In one embodiment of the method for manufacturing a color filter, the thicknesses of the light shielding layer and the color filter layer are the same so that the color filter layer has a smooth surface.

In one embodiment of the method for manufacturing a color filter, the cross-section of the black matrix layer perpendicular to the substrate is a trapezoid.

In one embodiment of the method for manufacturing a color filter, the substrate is a flexible substrate.

According to another embodiment of the disclosure, the disclosure provides a method for manufacturing a color filter comprises coating a light shielding layer on a substrate, then forming a trench on the light shielding layer through the water-cutting technique cutting the light shielding layer, then forming a black matrix layer and a sub-pixel region; the black matrix layer comprising a top surface and a bottom surface; the bottom surface bounded on the substrate; the top surface being at the surface of black matrix layer away from the substrate; the area of the bottom surface area being less than the area of the top surface; the black matrix layer and the sub-pixel region formed in an alternate interval manner; wherein each sub-pixel region is positioned between two adjacent black matrixes; then coating a pixel resin on the sub-pixel region; and carrying out a curing treatment by UV light to form a color filter layer at the sub-pixel region.

In one embodiment of the method for manufacturing a color filter, the process of cutting the light shielding layer uses an oblique cutting method.

In one embodiment of the method for manufacturing a color filter, the thicknesses of the light shielding layer and the color filter layer are the same so that the color filter layer has a smooth surface.

In one embodiment of the method for manufacturing a color filter, the cross-section of the black matrix layer perpendicular to the substrate is a trapezoid.

In one embodiment of the method for manufacturing a color filter, the substrate is a flexible substrate.

The present disclosure forms a trench on the light shielding layer to form a black matrix layer and a sub-pixel region. The present disclosure replaces the current technique of the lithography process by the low-temperature cutting technique to achieve the process of forming a trench and increases the quality of the substrate. The black matrix comprises a top surface and a bottom surface. The bottom surface is bounded on the substrate. The top surface is at the surface of black matrix layer away from the substrate. The bottom surface area is less than the top surface area. The color filter is provided with a smooth surface, without the step and the leakage of light is avoided according to the structure of the black matrix with a larger top and a smaller bottom.

### BRIEF DESCRIPTION OF THE DRAWINGS

In order to more clearly illustrate the prior art or the embodiments or aspects of the practice of the disclosure, the accompanying drawings for illustrating the prior art or the embodiments of the disclosure are briefly described as below. It is apparently that the drawings described below are merely some embodiments of the disclosure, and those skilled in the art may derive other drawings according the drawings described below without creative endeavor.

FIG. 1 is a schematic view of the light shielding layer coated on the substrate provided in accordance with the method for manufacturing the color filter of the embodiment of the disclosure;

FIG. 2 is a schematic view of the trench formed on the light shielding layer based on the FIG. 1; and

FIG. 3 is a schematic view of the sub-pixel region formed on the color filter layer based on the FIG. 2.

### DETAILED DESCRIPTION OF THE PREFERRED EMBODIMENTS

The following description with reference to the accompanying drawings is provided to clearly and completely explain the exemplary embodiments of the disclosure.

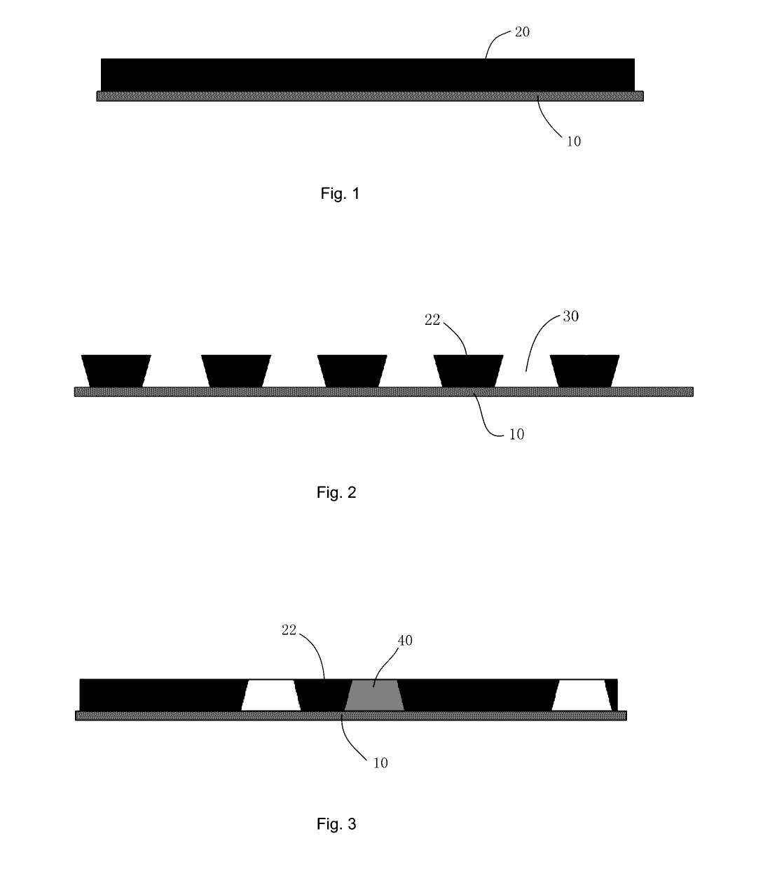

The disclosure is related the method for manufacturing the color filter, i.e. CF. FIG. 1 to FIG. 3 describes steps of the manufacturing process. The method for manufacturing the color filter of the disclosure comprises the following steps.

As shown in FIG. 1, a light shielding layer is coated on a surface of a substrate. Specifically, the substrate is a flexible substrate. The material of the substrate may also be glass, quartz, transparent resin and etc. The surface of the substrate is smooth to facilitate coating the light shielding layer. The step of coating the light shielding layer on the substrate comprises forming a film on the substrate in a brushing and/or a spraying manner, and then carrying out a curing treatment for the film by UV light.

A trench on the light shielding layer is formed to form a black matrix layer and a sub-pixel region. The light shielding layer is cut by water-cutting technique to form the trench on the light shielding layer. A plurality of the black matrixes is formed after cutting. Two adjacent black matrixes are spaced from each other. Each sub-pixel region is formed between two adjacent black matrixes. The black matrix layer and the sub-pixel region formed in an alternate interval manner. Furthermore, the process of cutting the light shielding layer uses an oblique cutting method. The area of the surface away from the substrate of each black matrix is larger than the area of the surface near the substrate of each black matrix. The cross-section of each black matrix layer perpendicular to the substrate is a trapezoid with a larger top and a smaller bottom. The shape of the black matrix can avoid the leakage of light at the color filter. Side surfaces of the trapezoidal black matrix are planar. In other embodiment, side surfaces of the trapezoidal black matrix are curved surfaces, especially the side surface close to the sub-pixel region. The curved surface can be a combination of various pieces of planes. It is necessary to keep the area of the surface away from the substrate of each black matrix larger than the area of the surface near the substrate of each black matrix to avoid the leakage of light.

The structure of each black matrix specifically comprises a top surface and a bottom surface. The bottom surface is bounded on the substrate. The top surface is at the surface of black matrix layer away from the substrate. The area of the bottom surface area is less than the area of the top surface.

The step of forming a color filter layer at the sub-pixel region comprises coating a pixel resin and then carrying out a curing treatment by UV light.

The thicknesses of the light shielding layer and the color filter layer are the same so that the color filter layer has a smooth surface.

The present disclosure forms a trench on the light shielding layer to form a black matrix layer and a sub-pixel region. The present disclosure replaces the current technique of the ultraviolet lithography process by the low-temperature cutting technique to achieve the process of forming a trench and increases the quality of the substrate. The black matrix comprises a top surface and a bottom surface. The bottom surface is bounded on the substrate. The top surface is at the surface of black matrix layer away from the substrate. The bottom surface area is less than the top surface area. The color filter is provided with smooth surface without the step and the leakage of light is avoided according to the structure of the black matrix with larger top and smaller bottom.

Note that the specifications relating to the above embodiments should be construed as exemplary rather than as limitative of the present disclosure. The equivalent variations and modifications on the structures or the process by reference to the specification and the drawings of the disclosure, or application to the other relevant technology fields directly or indirectly should be construed similarly as falling within the protection scope of the disclosure.

What is claimed is:

1. A method for manufacturing a color filter, comprising:
coating a light shielding layer on a substrate;
forming a trench on the light shielding layer to form a black matrix layer and a sub-pixel region; the black matrix layer comprising a top surface and a bottom surface; the bottom surface bounded on the substrate; the top surface being at the surface of black matrix layer away from the substrate; the area of the bottom surface being less than the area of the top surface; the black matrix layer and the sub-pixel region formed in an alternate interval manner; wherein each sub-pixel region is positioned between two adjacent black matrixes; and
forming a color filter layer at the sub-pixel region.

2. The method for manufacturing a color filter according to claim 1, the step of coating the light shielding layer on the substrate comprising:
forming a film on the substrate in a brushing and/or a spraying manner; and
carrying out a curing treatment for the film.

3. The method for manufacturing a color filter according to claim 2, wherein the film thickness is uniform.

4. The method for manufacturing a color filter according to claim 1, wherein the light shielding layer is cut by water-cutting technique to form the trench on the light shielding layer.

5. The method for manufacturing a color filter according to claim 4, wherein the process of cutting the light shielding layer uses an oblique cutting method.

6. The method for manufacturing a color filter according to claim 1, the step of forming a color filter layer at the sub-pixel region comprising:
coating a pixel resin; and
carrying out a curing treatment by UV light.

7. The method for manufacturing a color filter according to claim 1, wherein the thicknesses of the light shielding layer and the color filter layer are the same so that the color filter layer has a smooth surface.

8. The method for manufacturing a color filter according to claim 1, wherein the cross-section of the black matrix layer perpendicular to the substrate is a trapezoid.

9. The method for manufacturing a color filter according to claim 1, wherein the substrate is a flexible substrate.

10. A method for manufacturing a color filter, comprising:
coating a light shielding layer on a substrate;
forming the trench on the light shielding layer through the water-cutting technique cutting the light shielding layer;
forming a black matrix layer and a sub-pixel region; the black matrix layer comprising a top surface and a bottom surface; the bottom surface bounded on the substrate; the top surface being at the surface of black matrix layer away from the substrate; the area of the bottom surface being less than the area of the top surface; the black matrix layer and the sub-pixel region formed in an alternate interval manner; wherein each sub-pixel region is positioned between two adjacent black matrixes;
coating a pixel resin on the sub-pixel region; and
carrying out a curing treatment by UV light to form a color filter layer at the sub-pixel region.

11. The method for manufacturing a color filter according to claim 10, wherein the process of cutting the light shielding layer uses an oblique cutting method.

12. The method for manufacturing a color filter according to claim 10, wherein the thicknesses of the light shielding layer and the color filter layer are the same so that the color filter layer has a smooth surface.

13. The method for manufacturing a color filter according to claim 10, wherein the cross-section of the black matrix layer perpendicular to the substrate is a trapezoid.

14. The method for manufacturing a color filter according to claim 10, wherein the substrate is a flexible substrate.
